(19) United States
(12) Patent Application Publication
(10) Pub. No.: US 2018/0116255 A1
(43) Pub. Date: May 3, 2018

(54) PASTEURIZATION PLANT AND METHOD OF OPERATING A PASTEURIZATION PLANT

(71) Applicant: Red Bull GmbH, Fuschl am See (AT)

(72) Inventors: Gunnar DEMOULIN, Salzburg (AT); Roland CONCIN, Fuschl am See (AT); Christian RINDERER, Fuschl am See (AT)

(73) Assignee: Red Bull GmbH, Fuschl am See (AT)

(21) Appl. No.: 15/793,369

(22) Filed: Oct. 25, 2017

(30) Foreign Application Priority Data
Oct. 27, 2016 (AT) A50989/2016

(51) Int. Cl. A23L 3/02; C02F 1/44; C02F 1/00; B01D 65/02; B01D 63/04

(52) U.S. Cl. CPC A23L 3/02; C02F 1/44; C02F 1/008; B01D 65/02; A23V 2002/00; C02F 2209/40; C02F 2209/03; B01D 2321/04; B01D 63/04

(57) ABSTRACT

The invention relates to a method of operating a pasteurization plant whereby containers filled with food products and closed are treated with a tempered aqueous process liquid in one or more treatment zone(s). At least a part of the process liquid is circulated around the treatment zone(s) for reuse in at least one recirculation loop. A partial quantity of the process liquid circulated in the at least one recirculation loop is removed and fed to a cleaning device comprising a membrane filtration device. A flow rate through the membrane filtration device is continuously monitored by means of a sensor device. A volumetric flow through the membrane filtration device is influenced by adjusting a flow regulating position of at least one adjustable flow regulating means. The at least one partial flow is then returned to a recirculation loop or a treatment zone again.

The invention relates to a method of operating a pasteurization plant.

Pasteurization plants are used to preserve food products by tempering the food products in a specific way. In order to remove living microorganisms, the food products are usually heated to a higher temperature and maintained at this higher temperature for a specific time. In many cases, a practical approach is to pack the food products in containers and close the containers prior to the pasteurization process and a tempered or heated process liquid is applied to the external surface of the containers in order to heat and pasteurize the food products. In this manner, a product that is already suitable for storage and sale can be produced.

So-called tunnel pasteurizers are often used for this purpose, in which case containers which have already been filled with food products and then closed are fed through one or more treatment zones and are sprayed or drenched with a tempered process liquid in a respective treatment zone. An aqueous process liquid is usually used, which is recirculated around the treatment zone(s) in a circuit so that it can be at least partially reused. On the one hand, this reduces the quantity of fresh process liquid or fresh water which might need to be added to the system. On the other hand, the amount of energy needed to temper the process liquid can also be reduced.

When constantly reusing an aqueous process liquid and/or constantly recirculating process liquid, it is inevitable that contaminants will get into the aqueous process liquid during operation of the plant over time. Sources of such contaminants might be the ambient air, cooling towers used for cooling the process liquid if necessary and operating personnel for example, or the containers or their contents. For example, during the course of producing the containers, contaminants may be left on the external surface of the containers, for example due to processing steps involving the removal of material, etc. Situations may also arise in which constituents of the food products get into the process liquid during operation of a pasteurization plant due to slight leakages of containers. Leakages often occur in the region of the closures of the containers, for example in the case of screw caps on drink bottles or tabs on beverage cans. There may also be situations in which containers become damaged during the course of the treatment or beforehand or even burst.

Systems for constantly cleaning a reused process liquid of a pasteurization plant have already been proposed in the past. The proposed systems predominantly involve cleaning, primarily focusing on the removal of particulate substances by filtering and/or deposition. Such systems mainly involve a filtration of coarse substances or separating them using gravitational sedimentation, such as disclosed in EP 2 722 089 A1 for example. Systems whereby fine to very fine particulate substances, including microorganisms, can be removed from a process liquid circulating in a circuit have also already been proposed. In this respect, good results can be achieved with the system proposed in WO 2016/100996 A1, which WO 2016/100996 A1 is owned by this applicant.

However, there is still a need to develop an improved method for cleaning an aqueous process liquid in pasteurization plants, in particular with a view to optimizing continuous cleaning of a constantly reused process liquid as far as possible from both an ecological and economic point of view. There is more especially a need for improvement in the way in which cleaning of a tempered process liquid circulated in the circuit of pasteurization plants for reuse is specifically controlled, thereby making the cleaning process gentler on resources and more economical.

The objective of this invention was to propose an improved method of operating a pasteurization plant which enables an aqueous process liquid to be continuously cleaned as efficiently as possible.

This objective is achieved as specified in the claims.

The method proposed by the invention comprises conveying containers filled with food products and closed through one or more treatment zone(s). The containers are treated with a tempered aqueous process liquid in the treatment zone(s) by applying the process liquid to an external surface of the containers. As this happens, at least a part, preferably a predominant part, of the process liquid from the treatment zone(s) is fed back into a treatment zone again for reuse in at least one recirculation loop. At least a partial quantity of a volumetric flow of the process liquid fed respectively per unit of time via the at least one recirculation loop is removed or diverted from the at least one recirculation loop in order to create at least one partial flow, which at least one partial flow is directed through and filtered by a cleaning device comprising a membrane filtration device being fluidically connected to the at least one recirculation loop and having one or more filter module(s).

A flow rate and/or a volumetric flow of the at least one partial flow through the membrane filtration device and/or cleaning device is monitored by means of a sensor device. Furthermore, on the basis of the monitoring process, the partial quantity of process liquid removed from the at least one recirculation loop per unit of time is influenced with a view to obtaining a desired flow rate of the at least one partial flow through the membrane filtration device by adjusting a flow regulating position of at least one adjustable flow regulating means with respect to the membrane filtration device. Having circulated through the cleaning device, the at least one partial flow is returned to a recirculation loop or a treatment zone.

Due to the specified features, a method is provided by means of which coagulated impurities such as turbidities, dust particles, constituents of foodstuffs, parts of containers, precipitates, mucus, algae and/or microorganisms can be continuously removed from the process liquid in a highly efficient manner. In particular, monitoring and influencing the flow rate through the membrane filtration device ensures that a flow rate of the at least one partial flow through the membrane filtration device and/or the cleaning device can be adjusted and controlled so that it is high enough to achieve the necessary continuous removal of contaminants.

Furthermore, a contamination level of the process liquid can advantageously be detected and compensated as it varies over time. For example, an increased contamination level of the process liquid when the at least one flow regulating means is in a constant flow regulating position with respect to the membrane filtration device will have the effect of reducing a flow rate of the at least one partial flow through the membrane filtration device and/or cleaning device. The flow rate of the at least one partial flow through the membrane filtration device and hence the filtration efficiency can then be increased by making the flow regulating opening of the at least one flow regulating means with respect to the membrane filtration device larger. In the event of a low level of contaminants in the process liquid, the flow regulating opening of the at least one flow regulating means with respect to the membrane filtration device can be made smaller in order to reduce the flow rate of the at least one partial flow through the membrane filtration device. A flow rate and/or a volumetric flow of the at least one partial flow can therefore be adjusted to a respectively required level in an efficient manner.

All in all, the specified features advantageously result in effective, specifically controlled, continuous cleaning of the process liquid circulated in one or more recirculation loops. After circulating through the cleaning device, the at least one partial flow is preferably returned to the process liquid of the recirculation loop from which it was diverted. The advantage of this is that a temperature level of the at least one partial flow at least substantially corresponds to the temperature level of the process liquid circulating in the recirculation loop. There is therefore no need for additional tempering of the volumetric flow of process liquid returned to a treatment zone.

The advantage of cleaning a partial flow or several partial flows of process liquid in pasteurization plants in this manner is that the individual volumetric elements of the process liquid are constantly mixed due to the flow or forced flow of process liquid via the recirculation loop or recirculation loops. Such mixing is particularly effective in pasteurization plants where volumetric flows of process liquid are fed out of treatment zones and circulated respectively via recirculation loops back to other treatment zones again, for example. In other words, in such situations, individual volumetric elements of the process liquid are directed via changing recirculation loops and/or in and out of changing treatment zones during ongoing operation over time so that the entire process liquid is ultimately fed via a cleaning device over time. Consequently, by continuously cleaning only a partial quantity of the process liquid respectively by creating the partial flows, undesired contaminants are effectively removed from the entire process liquid over time.

Based on another embodiment of the method, a desired flow rate for the at least one partial flow through the membrane filtration device is selected from a range of between 0.1% and 50% relative to the volumetric flow of process liquid in the at least one recirculation loop prior to removing the partial flow.

By selecting the flow rate from the specified range, cleaning of the process liquid and/or the at least one partial flow of process liquid can be efficiently adapted respectively to a contamination level of the process liquid. The advantage of this is that the entire process liquid circulating in the pasteurization plant can be effectively cleaned by continuously removing and filtering a relatively small partial quantity of process liquid from the at least one recirculation loop. A desired flow rate for the at least one partial flow is preferably selected from a range of between 0.5% and 20% relative to the volumetric flow of process liquid in the at least one recirculation loop prior to removing the partial flow. To obtain efficient cleaning of the at least one partial flow, a total filtration capacity of the membrane filtration device and/or a number and respective filtration capacity of the filter module or filter modules of the membrane filtration device may naturally be adapted and/or selected accordingly.

Based on one preferred embodiment of the method, the partial quantity of process liquid removed from the at least one recirculation loop per unit of time with a view to obtaining a desired flow rate of the at least one partial flow through the membrane filtration device is influenced by adjusting an opening of the at least one flow regulating means into the membrane filtration device.

The advantage of adjusting an opening of a flow regulating means provided for this purpose is that the flow rate of the at least one partial flow through the membrane filtration device can be adjusted using relatively simple means but nevertheless in an efficient and precise manner. Another advantage of this is that it obviates the need for additional conveying means such as additional pumps for this purpose and the conveying means that are used to convey a volumetric flow of process liquid through a recirculation loop can also be used to circulate the at least one partial flow through the at least one cleaning device and/or membrane filtration device. Examples of flow regulating means having an opening into the membrane filtration device that can be adjusted are flap valves, poppet valves or 3-way distributor valves, among others. In such cases, the flow rate can in turn be increased by making the opening larger, in other words by adjusting the opening of the flow regulating means to obtain a larger opening into the membrane filtration device. Alternatively, the flow rate through the membrane filtration device can be reduced by making the opening into the membrane filtration device smaller.

Also of advantage is an embodiment of the method whereby a flow regulating position or opening position of the at least one adjustable flow regulating means with respect to the membrane filtration device is continuously monitored.

As a result, a respective flow regulating position or opening and/or opening position of the at least one flow regulating means is used as a monitoring and/or control means, for example for detecting a progressive build-up of a film on the membranes of the filter module or filter modules of the membrane filtration device.

In this context, if a threshold value for the flow regulating position or opening position of the at least one flow regulating means is exceeded, action can then be taken or initiated.

Enabling action to be taken when a threshold value for a flow regulating position or opening position is exceeded means that too large a drop in filtration efficiency during operation of the pasteurization plant can be prevented in good time, for example. The threshold value for the flow regulating position or opening position may be freely set and/or predefined in principle. For example, the maximum possible opening and/or the maximum opening position of the at least one flow regulating means might be selected or set as the threshold value.

However, action may also be taken if there is a drop below a threshold value for the detected flow rate and/or detected volumetric flow of the at least one partial flow diverted through the membrane filtration device.

This again enables too large a drop in filtration efficiency during operation of the pasteurization plant to be prevented in good time, for example. Again, the threshold value for the detected flow rate and/or detected volumetric flow of the at least one partial flow may be freely predefined in principle.

The action taken might be back-flushing by reversing a flow direction of one or more or all of the filter modules of the membrane filtration device, for example.

During the course of continuously filtering the at least one partial flow, the substances removed from or filtered out of the at least one partial flow in the filter module(s) of the membrane filtration device may be concentrated on a retentate side. As a result, deposits can build up on the retentate side of the membranes of the filter module or filter modules over time, which make it increasingly difficult for the process liquid to flow through the membranes. By back-flushing the filter module or filter modules, such deposits can be effectively removed from the filter membranes. As a result, it is advantageously made much easier for the at least one partial flow to flow through the filter membranes again so that sufficiently high flow rates for the at least one partial flow can be obtained again, even in the case of a minimal flow regulating position or small opening of the at least one flow regulating means into the membrane filtration device. Alternatively however, such back-flushing of the filter module or filter modules of the membrane filtration device may also take place at pre-definable times and/or at specific time intervals. In principle, all of the filter modules of the membrane filtration device may be back-flushed at the same time. Alternatively however, partial quantities of the filter modules may be back-flushed respectively in a sequential order or every filter module of the membrane filtration device may be back-flushed individually in a sequential order, for example.

Based on another embodiment of the method, the flow rate of the diverted partial flow is continuously monitored by means of a sensor device comprising a flow sensor.

As a result, an efficient sensor means can be used, by means of which a volumetric flow and/or a flow rate through the membrane filtration device can be directly detected and/or monitored.

Alternatively, however, a pressure drop across the membrane filtration device may be continuously monitored by means of a sensor device comprising a differential pressure sensor or at least two pressure sensors.

As a result, the ability of a flow to pass through the membrane filtration device can be monitored by means of a relatively inexpensive sensor means. Information about a flow rate through the membrane filtration device can also be gleaned. This is the case in particular in relation to a respective flow regulating position or opening position of the at least one flow regulating means with respect to the membrane filtration system.

Based on another embodiment of the method however, a flow rate of the process liquid through individual filter modules or groups of filter modules of the membrane filtration device may also be continuously monitored respectively by means of a sensor device.

In this manner for example, the states of individual filter modules or groups of filter modules, for example passability and/or blockages due to the build-up of deposits, can be monitored independently of one another respectively. The flow rates through the individual filter modules or groups of filter modules are added to obtain a total flow rate across the membrane filtration device.

In this context, if there is a drop below a threshold value respectively set for a flow rate through an individual filter module or a group of filter modules, the corresponding individual filter module or the corresponding group of filter modules can be back-flushed by reversing a flow direction.

The advantage of this is that the individual filter modules or groups of filter modules can be back-flushed independently of one another respectively so that filter modules that are not being back-flushed can continue to be operated in filtration mode. Also as a result of this feature, a blockage of the filter membranes due to a build-up of deposits can be respectively counteracted for individual filter modules or groups of filter modules separately on a selective basis in each case. As a result, this will avoid back-flushing filter modules for which no back-flushing is necessary at the time a back-flushing operation is implemented.

In principle, a respective flow rate of the process liquid through individual filter modules or groups of filter modules can be influenced respectively by means of a separate flow regulating means. As a result, a respective volumetric flow and/or a respective flow rate through a filter module and/or a group of filter modules can be influenced independently of other filter modules of the membrane filtration device. The respective flow rates through the individual filter modules are added to obtain a total flow rate of the at least one partial flow diverted from the at least one recirculation loop through the membrane filtration device.

However, it may also be of practical advantage if a gas flow is applied to the filter module(s) of the membrane filtration device on the retentate side, cyclically or as and when required.

The advantage of applying a gas flow on the retentate side is that particles can be detached from the filter membranes of the filter module or filter modules. Accordingly, deposits in the walls of the filter membranes on the retentate side can be broken up by blowing in gas, thereby counteracting the build-up of a film or blockage fluidically blocking the pores of the filter membranes. In addition, motion may be imparted to the filter membranes by the gas flow, in which case the deformation and agitation of the filter membranes will help to detach deposits. This will also be assisted by the frictional forces between the individual filter membranes, for example.

In particular, a gas flow may be applied to the retentate side of the filter module(s) of the membrane filtration device during a back-flushing operation.

In particular, this actively assists a back-flushing operation to remove deposits from the filter membranes of the filter module or filter modules of the membrane filtration device and a back-flushing operation can therefore be run much more efficiently.

Based on another preferred embodiment of the method, the flow rate of the at least one partial flow through the membrane filtration device and/or the flow regulating position or opening position of the at least one flow regulating means may be logged.

Logging or recording the flow rates and/or flow regulating positions or opening positions at least over a specific period of time enables changes in the state of the at least one cleaning device and/or membrane filtration device, and/or process liquid to be monitored. In this manner in particular, any states deviating from normal implementation of the method can be effectively detected on the basis of changes in the logged flow rates and/or flow regulating positions or opening positions over time that are atypical of the method. For example, an unusually high amount of contaminants getting into the process liquid, caused by a faulty or leaking batch of containers for example, can be detected. On the other hand, faults in or damage to the cleaning device itself can be detected, for example damaged or leaking filter modules or filter modules blocked by objects. In principle, a temperature level of the at least one partial flow deviating sharply from a desired temperature can be detected because the ability of the process liquid to pass through the filter membranes increases as the temperature of the process liquid rises and decreases as the temperature of the process liquid drops. In principle, such undesired deviations from normal operation compared with normal operation enable relatively large or rapid atypical changes in the monitored flow rate or monitored flow regulating position or opening position to be detected.

On detection of a change in the monitored flow rate of the at least one partial flow that is atypical of the method, or on detection of a change in the flow regulating position or opening position of the at least one flow regulating means that is atypical of the method, action can then be taken.

For example, such action might be to add at least one chemical selected from the group of pH regulators, water softeners, corrosion inhibitors, surfactants and antimicrobial substances to the process liquid.

Generally speaking, chemical constituents in the process liquid can lead to undesired effects. For example, an unsuitable pH value of the process liquid can lead to undesired flocculation of other constituents or to undesired interactions with the containers. Corrosive substances can generally lead to detachment, for example from devices of the pasteurization plant itself. Hard water salts, for example, can also lead to the coagulation and/or formation of undesired particles. Furthermore, account must be taken of any respective growth rate or propagation rate of microorganisms, such as bacterial cultures or algae, which may reach considerable levels due to nutrients dissolved in the process liquid. This can even be promoted by other parameters of the process liquid, such as an increased temperature level. Admixing or adding chemicals when a state atypical of the method is detected, for example a sharp drop in a flow rate through the membrane filtration device, such undesired effects can be counteracted by adding specific types and amounts of chemicals.

Furthermore, the action taken might be to undertake maintenance work on the cleaning device or pasteurization plant.

As a result, faults in the method or damage to the pasteurization plant, in particular damage to the cleaning device, for example a damaged filter module, detected because a state atypical of the method has been detected can then be repaired.

Based on one embodiment of the method, it may be of practical advantage if the food products in the containers are heated in a treatment zone or heated in several treatment zones successively, then pasteurized in a treatment zone or several treatment zones, after which they are cooled in a treatment zone or cooled in several treatment zones successively.

This makes for a particularly gentle pasteurization process for the food products because large jumps in the temperature of the tempered process liquid can be avoided. Furthermore, tempering of the food products in a respective container is more even.

In this case in particular, the at least one partial flow is removed from a recirculation loop in which the flow of process liquid is at a temperature level of between 30 and 55° C.

At a temperature of the process liquid in the specified range, particularly good filtration results can be obtained on the one hand because the process liquid is able to pass through the filter membranes of the filter module or filter modules. On the other hand, this actively prevents damage to the filter membranes, in particular plastic membranes. The at least one partial flow is preferably removed from a recirculation loop in which the flow of process liquid is at a temperature level of between 20 and 60° C.

Finally, another embodiment of the method is of advantage whereby a partial volumetric flow of process liquid is directed though a heat exchanger of a cooling device depending on requirements.

The efficiency of the process for cleaning the process liquid can also be increased as a result of this feature. This is primarily the case because contaminants can be prevented from getting into the process liquid due to and/or in the cooling device. Cooling devices are often needed for cooling a part of the process liquid, which cooled process liquid can in turn be used for cooling containers once the pasteurization process has been completed, for example. Due to the usually high cooling capacity required, the amount of entrained contaminants, for example in the case of conventional cooling towers without heat exchangers, can be very high indeed.

To provide a clearer understanding, the invention will be described in more detail below with reference to the appended drawings.

These are highly simplified, schematic diagrams respectively illustrating the following:

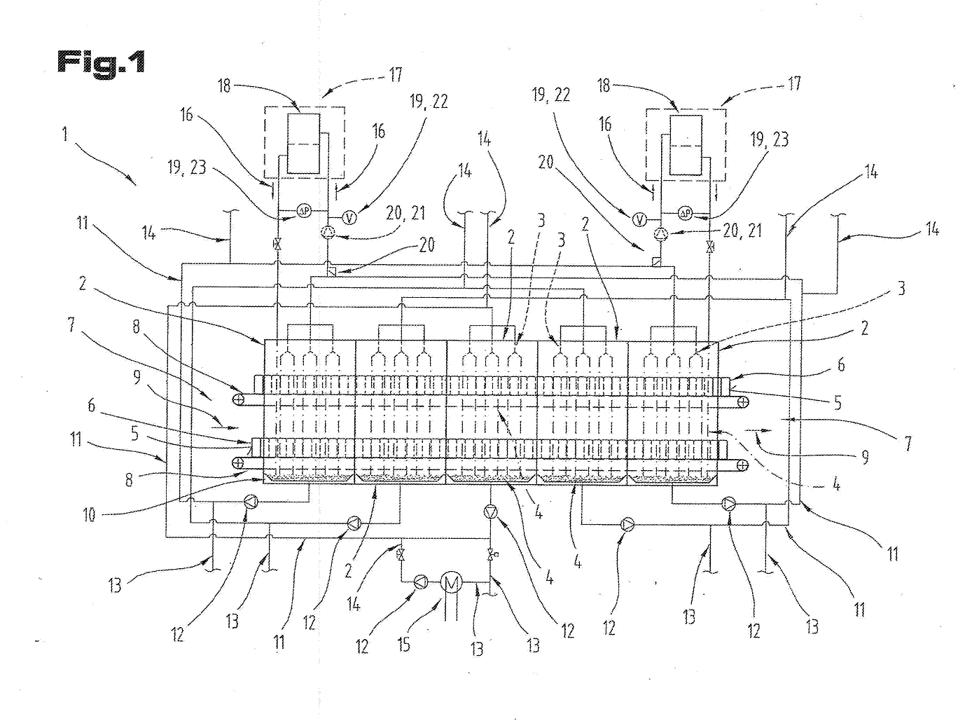

FIG. 1 a schematic diagram illustrating one example of an embodiment of a pasteurization plant;

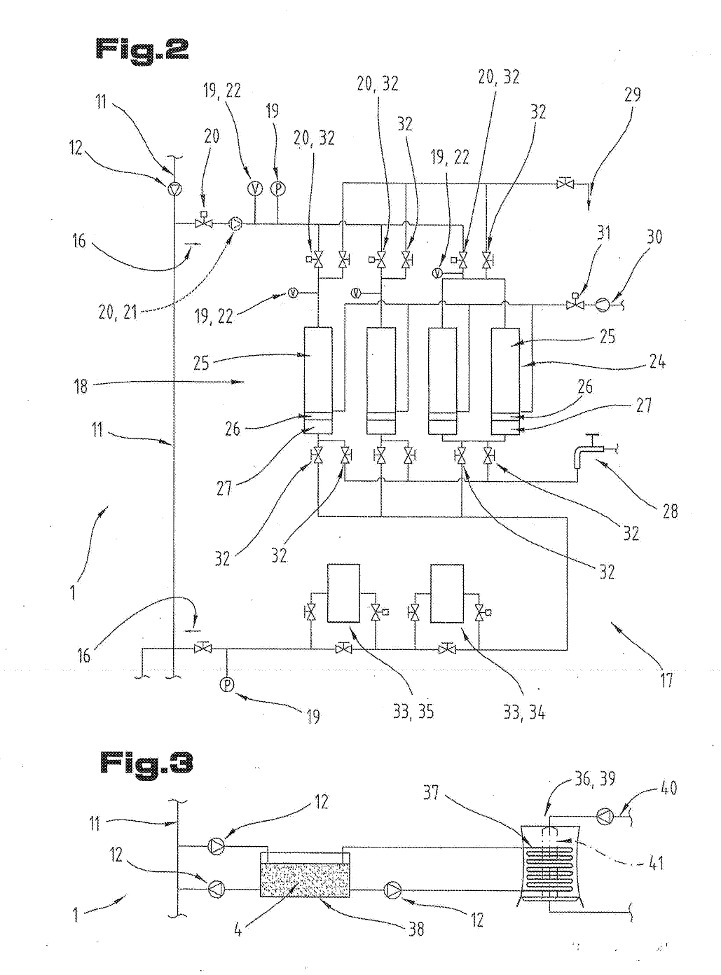

FIG. 2 a schematic diagram illustrating one example of an embodiment of a cleaning device of the pasteurization plant;

FIG. 3 a detail of a schematic diagram illustrating parts of an example of another embodiment of the pasteurization plant.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described.

FIG. 1 schematically illustrates an example of an embodiment of a pasteurization plant 1. The pasteurization plant 1 comprises one or more treatment zone(s) 2 with delivery means 3 for applying a process liquid 4 to an external surface 5 of containers 6. In the embodiment illustrated as an example in FIG. 1, 5 treatment zones 2 are illustrated by way of example but it goes without saying that it would also be possible to provide more or fewer treatment zone(s) 2 depending on the requirements and design of a pasteurization plant 1.

Food products are pasteurized during operation of the pasteurization plant 1 and the containers 6 are firstly filled with the food products and the containers 6 are then closed. The containers 6 filled with the food products and then closed are treated in a respective treatment zone 2 by applying an aqueous process liquid 4 to an external surface 5 of the containers 6 via the delivery means 3. The delivery means 3 of a respective treatment zone 2 may be provided in the form of sprinkler or nozzle type spraying means or generally means for distributing the process liquid in a respective treatment zone 2. The tempered aqueous process liquid 4 is applied to the external surface 5 of the containers 6 in this manner so that the containers 6 and hence the food products packaged in the containers 6 can be tempered in a specific way and pasteurized. The containers may be of different types, for example bottles, cans or other receptacles, and in principle may be made from various materials which may optionally be coated or printed.

In order to convey the containers 6 through the treatment zone(s) 2, a conveyor device 7 is provided. In the embodiment illustrated as an example in FIG. 1, the conveyor device 7 comprises two driven conveyor belts 8 by means of which the containers 6 which have been filled with food products and closed are conveyed through the treatment zone(s) 2 on two levels during operation of the pasteurization plant 1. This may be done from left to right, for example, in a conveying direction 9 indicated by arrows in FIG. 1.

During operation of the pasteurization plant 1, the food products in the containers 6 can be heated first of all in a treatment zone 2 or in several treatment zones 2. In the embodiment illustrated as an example in FIG. 1, the food products and containers 6 can be successively heated in the two treatment zones 2 illustrated on the left-hand side in FIG. 1, for example. After heating, the food products can be pasteurized in a treatment zone 2 or several treatment zones 2, for example by applying a process liquid 4 appropriately tempered for pasteurization purposes in the treatment zone 2 illustrated in the center in FIG. 1. The food products and containers 6 can then be cooled in a treatment zone 2 or in several treatment zones 2. The containers 6 can be successively cooled by applying a process liquid 4 at a temperature suitable for cooling purposes in the two treatment zones 2 illustrated on the right-hand side in FIG. 1.

For example, the food products are heated in treatment zone 2 disposed first of all in the conveying direction 9 and are then further heated in the next treatment zone 2 disposed in the conveying direction 9. In the next treatment zone 2 disposed in the conveying direction 9, the food products can then be pasteurized by applying a process liquid 4 at a particularly high temperature, for example between 50° C. and 110° C., to the external surface 5 of the containers 6. In the next two treatment zones 2 disposed in the conveying direction 9, the food products and containers 6 can then be cooled in a specific manner using an appropriately tempered cooler process liquid 4. The main advantage of this is that the food products are pasteurized as gently as possible, in particular without the tempering process itself causing damage to the food products.

After applying the tempered process liquid 4 to the external surface 5 of the containers 6 in the treatment zone(s) 2, the process liquid can be collected in a bottom floor region 10 of a respective treatment zone 2 and fed back out of a respective treatment zone 2. In order to discharge the process liquid 4 from the treatment zone(s) 2 and return at least a part of the discharged process liquid 4 to a treatment zone 2 or to one of the treatment zones 2, the pasteurization plant 1 comprises at least one recirculation loop 11. During operation of the pasteurization plant 1, therefore, at least a part of the process liquid 4, preferably a predominant part of the process liquid 4 or the entire process liquid 4, is fed out of the treatment zone(s) 2 for reuse in this at least one recirculation loop 11 and back into a treatment zone 2 again by means of a conveying means 12.

As may be seen from the embodiment illustrated as an example in FIG. 1, the process liquid 4 is fed out of a treatment zone 2 via a recirculation loop 11 and fed into another treatment zone 2, for example. In the embodiment illustrated as an example, the process liquid 4 is fed out of the treatment zone 2 shown on the far left-hand side via a recirculation loop 11 and into the treatment zone 2 shown on the far right-hand side, for example. Conversely, the process liquid 4 can be fed out of the treatment zone 2 shown on the far right-hand side via a recirculation loop 11 into the treatment zone 2 shown on the far left-hand side for heating the containers 6 and food products, for example. This may be of particular advantage because the process liquid 4 is cooled or heated accordingly whilst it is being applied to and is acting on the containers 6. Due to this cooling and/or heating, the process liquid 4 from one respective treatment zone 2 may therefore be at a suitable temperature for another treatment zone 2. Alternatively, it may also be of advantage if the process liquid 4 from a treatment zone 2 is fed via a recirculation loop 11 back into the same treatment zone 2, as may be seen in the case of treatment zone 2 illustrated in the middle in FIG. 1 which is used to pasteurize the food products.

In order to convey and/or direct respective volumetric flows of process liquid 4 in the recirculation loop 11 or in the recirculation loops 11, conveying means 12 may be respectively provided, for example pumps, as illustrated in FIG. 1. Furthermore, the pasteurization plant 1 is provided with means 13 for discharging parts of the process liquid 4 from the recirculation loop 11 and/or out of the recirculation loops 11, for example for sampling purposes. Furthermore, the pasteurization plant 1 may also comprise means 14 for feeding in substances such as fresh process liquid 4, for example fresh water, or chemicals, etc. Such means 13, 14 might be provided in the form of pipes, for example, which are run so as to feed process liquid 4 into and/or out of collection tanks, etc., or which means 13, 14 are fluidically connected to heating and/or cooling devices for the purpose of tempering process liquid. A heating device 15 is illustrated by way of example in FIG. 1, for example a steam heater or a heat pump, which heating device 15 is fluidically connected via means 13, 14 to the recirculation loop 11 in order to return process liquid 4 to the centrally illustrated treatment zone 2. In this manner, the process liquid for this recirculation loop 11 can be respectively heated to the temperature needed for the process of pasteurizing the food products.

Due to the continuous circulation of the process liquid 4 via the recirculation loop 11 or recirculation loops 11 and/or the continuous reuse of the process liquid 4 during operation of the pasteurization plant 1, contaminants and/or undesired substances can get into the aqueous process liquid over time. Based on the method of operating a pasteurization plant 1, therefore, at least one partial quantity of a volumetric flow of process liquid 4 circulating via the at least one recirculation loop 11 is removed or diverted per unit of time in order to create at least one partial flow 16 and this at least one partial flow 16 is circulated through a cleaning device 17 comprising a membrane filtration device 18 having one or more filter module(s) fluidically connected to the at least one recirculation loop 11 and filtered, as illustrated in FIG. 1.

In the embodiment illustrated as an example in FIG. 1, two cleaning devices 17 respectively comprising a membrane filtration device 18 are illustrated by way of example, which cleaning devices 17 are fluidically connected to different recirculation loops 11 respectively. Naturally, it would also be possible to provide only one cleaning device 17 or a pasteurization plant 1 may also have more than two cleaning devices 17. The number of cleaning device(s) 17 and also a filtration capacity of a respective membrane filtration device 18 will be selected and/or set respectively taking account of the size and treatment capacity of a respective pasteurization plant 1 amongst other things. Furthermore, it would also be perfectly possible to provide several cleaning devices 17 fluidically connected to a recirculation loop 11 and/or to one of the recirculation loops 11.

The process liquid 4 overall or the entire process liquid 4 of the pasteurization plant is cleaned by continuously removing and filtering the at least one partial flow 16. The advantage of this is that as part of the method of operating the pasteurization plant 1, the individual volumetric elements of the process liquid 4 are constantly being mixed due to the flow and/or forced flow of the process liquid via the recirculation loop 11 or recirculation loops 11. In other words, in such situations, individual volumetric elements of the process liquid 4 are directed via changing recirculation loops 11 and/or in and out of changing treatment zones 2 during ongoing operation over time so that the entire process liquid 4 is ultimately filtered by means of the membrane filtration system(s) 18.

In order to improve filtration efficiency and/or control cleaning of the at least one partial flow 16 and monitor the method, a flow rate and/or a volumetric flow of the at least one partial flow 16 through the membrane filtration device 18 is continuously monitored by means of a sensor device 19. Furthermore, on the basis of monitoring, the partial quantity of process liquid 4 removed from the at least one recirculation loop 11 per unit of time is influenced with a view to obtaining a desired flow rate of the at least one partial flow 16 through the membrane filtration device 18 by adjusting a flow regulating position of the at least one adjustable flow regulating means 20 into the membrane filtration device 18. After circulating through the cleaning device 17 and/or the membrane filtration device 18, the at least one partial flow 16 is returned to a recirculation loop 11 or a treatment zone 2 again, as illustrated in FIG. 1.

The at least one diverted partial flow 16 is preferably returned to the process liquid 4 of the recirculation loop 11 from which it was removed. This is of advantage amongst other things because a temperature level of the at least one partial flow 16 at least substantially corresponds to the temperature level of the process liquid 4 circulating in the recirculation loop 11.

Flow regulating means 20 for the two membrane filtration devices 18 and/or cleaning devices 17 are illustrated in FIG. 1 but only on a highly simplified schematic basis. A flow regulating means 20 may be provided in the form of a speed-controllable pump 21 as indicated by broken lines in FIG. 1 or a similar conveying means which can be regulated, for example. In such a case, in order to influence the flow rate of the at least one partial flow 16 through the membrane filtration device 18, the flow regulating opening into the membrane filtration device 18 is adjusted by adjusting the speed of the controllable pump 21, i.e. increasing or decreasing it.

The method is preferably implemented in such a way that the partial quantity of process liquid 4 removed from the at least one recirculation loop 11 per unit of time is influenced with a view to obtaining a desired flow rate of the at least one partial flow 16 through the membrane filtration device 18 by adjusting an opening of the at least one flow regulating means 20 into the membrane filtration device 18. Examples of flow regulating means whereby an opening into the membrane filtration device 18 can be adjusted are flap valves, poppet valves or 3-way distributor valves, among others. By means of such flow regulating means 20, an opening and/or opening position into the membrane filtration device 18 and hence the flow rate and/or volumetric flow of the at least one partial flow 16 through the at least one cleaning device 17 and/or membrane filtration device 18 can be made larger or smaller respectively depending on requirements. This being the case, the filtration efficiency can then be respectively increased or lowered. Possible opening positions of such flow regulating means 20 might be between a maximum opening position into the membrane filtration device 18 and an opening position that completely closes off the membrane filtration device 18, for example.

In principle, it would naturally also be possible to provide several flow regulating means 20 which are then used and adjusted in combination with one another in order to control removal of the at least one partial quantity of process liquid 4 from the at least one recirculation loop 11 and/or to control the flow rate of the at least one partial flow 16 through the membrane filtration device 18.

A desired flow rate for the at least one partial flow 16 through the membrane filtration device 18 is preferably selected from a range of between 0.1% and 50% relative to the volumetric flow of process liquid 4 in the at least one recirculation loop 11 prior to removing the partial flow 16. In particular, a flow rate for the at least one partial flow 11 may be selected from a range of between 0.5% and 20% relative to the volumetric flow of process liquid 4 in the at least one recirculation loop 11 prior to removing the partial flow 16.

It may also be of practical advantage if the at least one partial flow 16 is removed from a recirculation loop 11 in which the flow of process liquid 4 has a temperature level of between 20 and 60° C. When the process liquid 4 is at a temperature within the specified range, particularly good filtration results can be obtained on the one hand because the process liquid 4 is able to pass easily through the filter membranes of the filter module or filter modules of the membrane filtration device 18. On the other hand, damage to the filter membranes can be actively prevented, particularly in the case of plastic membranes. The at least one partial flow 16 is preferably removed from a recirculation loop 11 in which the flow of process liquid 4 has a temperature level of between 30 and 55° C.

A respective flow rate and/or a respective volumetric flow of the at least one partial flow 16 through the membrane filtration device 18 may be monitored by means of a sensor device 19 comprising a flow sensor 22 for example, as also illustrated in FIG. 1. However, a pressure drop across the membrane filtration device 18 may be continuously monitored by means of a sensor device 19 comprising a differential pressure sensor 23 or at least two pressure sensors, as likewise illustrated in FIG. 1. Again in the latter case using a respective flow regulating position or opening position of the at least one flow regulating means 20 into the membrane filtration system 18, a flow rate of the at least one partial flow 16 through the membrane filtration device 18 can be estimated.

Irrespective of the above, however, it may also be of practical advantage if a flow regulating position or opening position of the at least one adjustable flow regulating means 20 into the membrane filtration device 18 is continuously monitored. This is primarily of advantage because it offers a means of checking and/or monitoring a state such as the degree of contamination of the process liquid 4 and/or cleaning device 17 and/or membrane filtration device 18.

This being the case, fluidic threshold values can then be selected and/or set respectively for the sensor-monitored flow rate of the at least one partial flow 16 through the membrane filtration device 18 and/or for the monitored flow regulating position or opening position of the at least one flow regulating means 20, for example.

As a result, action can be taken and/or initiated if a threshold value for the flow regulating position or opening position of the at least one flow regulating means 20 is exceeded, for example. Alternatively or in addition, action can be taken if there is a drop below a threshold value for the monitored flow rate of the at least one diverted partial flow 16 through the membrane filtration device 18.

In this respect, the action taken might be at least back-flushing by reversing a flow direction of a filter module or several or all of the filter modules of the membrane filtration device 18, as will be explained with reference to the embodiment of a cleaning device 17 and parts of a pasteurization plant 1 illustrated as an example in FIG. 2. In FIG. 2, the same reference numbers and component names are used to denote parts that are the same as those described with reference to FIG. 1 above. To avoid unnecessary repetition, reference may be made to the detailed description of FIG. 1 above.

As may be seen from FIG. 2, the membrane filtration device 18 of the cleaning device 17 may comprise several filter modules 24 and 4 filter modules 24 are illustrated in FIG. 2, purely by way of example. The number of filter modules 24 and also the filtration capacity of the filter modules 26 may be selected respectively depending on a contamination level to be anticipated and/or adapted to the volume of process liquid circulated through the pasteurization plant 1 as a whole during operation. In principle, the filter modules 24 of the membrane filtration device 18 may be arranged in the membrane filtration device 18 in any manner, for example fluidically connected in series one after the other. In the embodiment illustrated as an example in FIG. 2, the filter modules 24 are fluidically connected in parallel with one another so that a partial quantity of the partial flow 16 can respectively be circulated across or through the filter modules 24.

The individual filter modules 24 may basically also be of any design provided they enable a tempered aqueous process liquid to be filtered. A filter module 24 may comprise a plurality of hollow fiber membranes for example, which may be mounted in a retentate chamber 25 on the intake side. These hollow fiber membranes may have pores with a pore diameter of between 0.01 μm and 0.5 μm for example, thus being suitable for micro- and/or ultra-filtration. The respectively open ends of the hollow fiber membranes of a filter module 24 may be embedded in a sealing means 26 in such a way that the open ends and the inner cavities of the hollow fibers open into a filtrate or permeate chamber 27 of a filter module 24. Accordingly, the sealing means 26 separate the retentate chamber 25 from the permeate chamber 27 in a sealed arrangement so that the at least one partial flow 16 of aqueous process liquid can only flow from the retentate chambers 25 by passing through the hollow fiber membrane walls from an external surface of the hollow fiber membranes into the interior of the hollow fibers and into the permeate chambers 27 of the filter modules 24. The at least one partial flow 16 is thus filtered and particulate and/or coagulated impurities are held back on the retentate side.

As also illustrated in FIG. 2, the filter modules 24 of a membrane filtration device 18 can be respectively connected on the permeate or filtrate side to a back-flush liquid source 28 and on the retentate or intake side to a discharge 29 by pipes which can be shut off or opened as and when required. As a result, the filter modules 24 of the membrane filtration device 18 can be cleaned with a back-flushing liquid by reversing the flow direction through the filter modules 24 in order to clean the filter membranes, for example the hollow fiber membranes. For example, a filter cake can be removed from the retentate side of the filter membranes in this manner. In this respect, all of the filter modules 24 of a membrane filtration device 18 can be cleaned together. Alternatively, however, it may be that groups of filter modules or even every filter module 24 separately is connected to a back-flush liquid source 28 and a discharge 29 and can be selectively shut off or opened, as also illustrated in FIG. 2. Clean fresh water may be used as the back-flushing liquid, for example, to which cleaning chemicals may be added if necessary.

In addition, the filter module(s) 24 of the membrane filtration device 18 may be flushed with a gas flow on the retentate side, in cycles or as and when required. To this end, the filter module(s) 24 may be connected by pipes to a gas source 30, for example an air blower or a compressor. In principle, every filter module 24 may be connected separately or as groups of filter modules 24 to a gas source 30 via a shut-off element 31 which can respectively be shut off or opened. In the embodiment illustrated as an example in FIG. 2, all of the filter modules 24 of the membrane filtration device 18 are connected to the gas source 30 via a common shut-off element 31 which can be selectively shut off or opened, but this is but one example.

In particular, a gas flow may be applied to the filter module(s) 24 of the membrane filtration device 18 on the retentate side during a back-flushing operation. This actively assists the process of cleaning the filter module(s) by back-flushing.

As may be seen from the embodiment illustrated as an example in FIG. 2, a flow rate and/or a volumetric flow of process liquid through individual filter modules 24, for example the two filter modules 24 illustrated on the left-hand side in FIG. 2, or groups of filter modules 24 of the membrane filtration device 18, for example the group of two filter modules 24 illustrated on the right-hand side in FIG. 2, may also be continuously monitored respectively by means of a sensor device 19 comprising a flow sensor 22, for example. Accordingly, the measured flow rates through the individual filter modules 24 or groups of filter modules 24 are added to obtain a total flow rate through the membrane filtration device 18.

As may also be seen from FIG. 2, if there is a drop below a respectively set threshold value for a flow rate through an individual filter module 24 or a group of filter modules 24, the corresponding individual filter module 24 or the corresponding group of filter modules 24 can be back-flushed by reversing a flow direction. This is possible in the case of the embodiment illustrated as an example in FIG. 2 because the two filter modules illustrated on the left-hand side and the group of two filter modules 24 illustrated on the right-hand side can each be selectively shut off from or connected to the back-flush liquid source 28 and discharge 29, respectively the recirculation loop 11 via shut-off means 32 independently of one another.

In principle, however, it would also be conceivable for a flow rate and/or volumetric flow of the process liquid through individual filter modules 24 or groups of filter modules 24 to be influenced respectively by means of a separate flow regulating means 20, as also illustrated in FIG. 2. The respective flow rates through the individual filter modules 24 are then added to obtain a total flow rate of the at least one partial flow 16 diverted from the at least one recirculation loop 11 through the membrane filtration device 18. A respective flow regulating means 20 provided for this purpose may also be used as a shut-off means 32 from the recirculation loop 11.

Based on another preferred embodiment of the method, the flow rate of the at least one partial flow 16 through the membrane filtration device 18 and/or the flow regulating position or opening position of the at least one flow regulating means 20 may be logged, in other words recorded, for a specific period of time. The logged data of the flow rates of the at least one partial flow 16 over time and/or the logged data of the flow regulating positions or opening positions of the at least one flow regulating means 20 over time may advantageously provide information about states of the at least one cleaning device 17 and/or membrane filtration device 18. Also in this manner, information can be gleaned about the state of the process liquid and/or the quality of the process liquid. In particular on the basis of this logged data, a content of various constituents of the process liquid can be estimated, such as turbidities, coagulated substances, dust or other particulate contaminants, microorganisms, or mucus forming substances, for example. For example, an unusually high proliferation or extraordinary growth of microorganisms-cultures over time may be detected as indicating an atypical drop of a flow rate or a flow regulating position or opening position that has become atypically large.

When a change in the monitored flow rate of the at least one partial flow 16 that is atypical of the method is detected or if a change in the flow regulating position or opening position of the at least one flow regulating means 20 that is atypical of the method is detected, action can then be taken. For example, based on an analysis of the logged data plotted over time, an atypical change deviating from a normal operation of the at least one cleaning device 17 and/or membrane filtration device 18 can therefore be detected. Cycles of slightly fluctuating flow regulating positions or opening positions of the at least one flow regulating means 20 due to a changing filtration operation or back-flushing operation would constitute normal operation of the membrane filtration device 18, for example. If it is detected or ascertained that the logged data plotted over time has deviated from this, in other words there has been a change in the logged data for flow rates and/or flow regulating positions or opening positions plotted over time that is atypical of the method, action can then be taken or initiated.

For example, the action might be to add at least one chemical to the process liquid. This might be done with a view to dissolving coagulated substances or with a view to changing or adjusting the chemical composition or other parameters of the process liquid. For example, an unsuitable pH value of the process liquid can lead to undesired flocculation of other constituents or to undesired interactions with the containers. Corrosive substances can generally lead to detachment, for example from devices of the pasteurization plant 1 itself. Hard water salts, for example, can also lead to the coagulation and/or formation of undesired particles. Furthermore, account must be taken of any respective growth rate or propagation rate of microorganisms, such as bacterial cultures or algae, which may reach considerable levels due to nutrients dissolved in the process liquid. This can even be promoted by other parameters of the process liquid, such as an increased temperature level. In particular, the at least one chemical may be selected from the group of pH regulators, water softeners, corrosion inhibitors, surfactants and antimicrobial substances. Chemicals can be added to the process liquid by the means 14 and/or pipes illustrated in FIG. 1 for example or in some other way and at different points.

In principle, however, damage to the at least one cleaning device 17 or membrane filtration device 18, for example a damaged filter module 24, or other states in the pasteurization plant 1 itself that are atypical of the method may also be detected on the basis of the logged data for flow rates through the membrane filtration device 18 and/or flow regulating positions or opening positions of the at least one flow regulating means 20. Consequently, the action taken might be to undertake maintenance work on the cleaning device 17 or pasteurization plant 1.

Generally speaking, the at least one cleaning device 17 of the pasteurization plant 1 may comprise yet other cleaning modules for continuously cleaning the at least one partial flow 16 and/or to remove other undesired contaminants from the at least one partial flow 16, as schematically indicated in FIG. 2. Such other cleaning modules 33 might be for example ion exchange devices 34 or adsorption devices 35 by means of which dissolved substances can also be removed from the process liquid, for example.

FIG. 3, finally, illustrates parts of another example of an embodiment of a pasteurization plant 1 which may be of advantage in terms of continuously reusing and cleaning the process liquid 4. In FIG. 3, the same reference numbers and component names are used for parts that are the same as those described with reference to FIGS. 1 and 2. To avoid unnecessary repetition, reference may be made to the more detailed description of FIG. 1 and FIG. 2 above.

As may be seem from the parts of the embodiment of the pasteurization plant 1 illustrated as an example in FIG. 3, the pasteurization plant 1 comprises a cooling device 36 having a heat exchanger 37 through which the process liquid 4 can be circulated if necessary. In this manner, a partial volumetric flow of process liquid 4 can be circulated through a heat exchanger 37 of a cooling device 36, depending on requirements.

Such cooling devices 36 are often needed in pasteurization plants for cooling a part of the process liquid 4, which cooled process liquid 4 can in turn be used to cool containers on completion of the pasteurization process, for example. Providing the heat exchanger 37 actively prevents contaminants from getting into the process liquid 4, for example due to and/or in a conventional air-cooled cooling tower 36.

As illustrated in FIG. 3, in order to cool a partial quantity of process liquid 4 for example, a partial quantity of process liquid 4 is transferred from a recirculation loop 11 by means of conveying means 12 into a process liquid tank 38, for example a collection tank or similar, depending on requirements. Also depending on requirements, process liquid 4 can then be pumped out of the process liquid tank 38 though the heat exchanger 37 by means of another conveying means 12, and thus cooled by cooling air for example and then returned to the process liquid tank 38 again. In FIG. 3, a cooling tower 39 is illustrated as an example of a cooling device 36, to which cooling tower 39 coolant 41 can be delivered via a coolant circuit 40. The cooled process liquid 4 from the process liquid tank 38 can then be delivered to the recirculation loop 11 illustrated by way of example in FIG. 3.

The method features specified throughout this document may be partially manually implemented, in principle. The features are preferably at least predominantly controlled on an automated basis by means of one or more control devices connected in a signal-transmitting arrangement.

The embodiments illustrated as examples represent possible variants, and it should be pointed out at this stage that the invention is not specifically limited to the variants specifically illustrated, and instead the individual variants may be used in different combinations with one another and these possible variations lie within the reach of the person skilled in this technical field given the disclosed technical teaching.

The protective scope is defined by the claims. The description and drawings may be used to interpret the claims. Individual features or combinations of features from the different embodiments illustrated and described may be construed as independent inventive solutions or solutions proposed by the invention in their own right. The objective underlying the independent inventive solutions may be found in the description.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

For the sake of good order, finally, it should be pointed out that, in order to provide a clearer understanding of structure, some elements are illustrated to a certain extent out of scale and/or on an enlarged scale and/or on a reduced scale.

List of reference numbers

| | |
|---|---|
| 1 | Pasteurization plant |
| 2 | Treatment zone |
| 3 | Delivery means |
| 4 | Process liquid |
| 5 | External face |
| 6 | Containers |
| 7 | Conveyor device |
| 8 | Conveyor belt |
| 9 | Conveyor device |
| 10 | Floor region |
| 11 | Circulating circuit |
| 12 | Conveying means |
| 13 | Means |
| 14 | Means |
| 15 | Heating device |
| 16 | Partial flow |
| 17 | Cleaning device |
| 18 | Membrane filtration device |
| 19 | Sensor device |
| 20 | Flow regulating means |
| 21 | Pump |
| 22 | Flow sensor |
| 23 | Differential pressure sensor |
| 24 | Filter module |
| 25 | Retentate chamber |
| 26 | Sealing means |
| 27 | Permeate chamber |
| 28 | Back-flush liquid source |
| 29 | Discharge |
| 30 | Gas source |
| 31 | Shut-off element |
| 32 | Shut-off means |
| 33 | Cleaning module |
| 34 | Ion exchange device |
| 35 | Adsorption device |
| 36 | Cooling device |
| 37 | Heat exchanger |
| 38 | Process liquid tank |
| 39 | Cooling tower |
| 40 | Coolant circuit |
| 41 | Coolant |

1: Method of operating a pasteurization plant (1), comprising
conveying containers (6) filled with food products and closed through one or more treatment zone(s) (2),
treating the containers (6) with a tempered aqueous process liquid (4) in the treatment zone(s) (2) by applying the process liquid (4) to an external surface (24) of the containers (6),
wherein at least a part of the process liquid (4) from the treatment zone(s) (2) is fed back into a treatment zone (2) again for reuse in at least one recirculation loop (11) by means of a conveying means (12),
and at least a partial quantity of a volumetric flow of the process liquid (4) fed per unit of time via the at least one recirculation loop (11) is diverted in order to create at least one partial flow (16),
which at least one partial flow (16) is directed through and filtered by a cleaning device (17) comprising a membrane filtration device (18) being fluidically connected to the at least one recirculation loop (11) and having one or more filter module(s) (24),
wherein
a flow rate of the at least one partial flow (16) through the membrane filtration device (18) is continuously monitored by means of a sensor device (19) and on the basis of the monitoring, the partial quantity of process liquid (4) removed from the at least one recirculation loop (11) per unit of time is influenced with a view to obtaining a desired flow rate of the at least one partial flow (16) through the membrane filtration device (18) by adjusting a flow regulating position of at least one adjustable flow regulating means (20) with respect to the membrane filtration device (18),
and having circulated through the cleaning device (17), the at least one partial flow (16) is returned to a recirculation loop (11) or a treatment zone (2) again.

2: Method according to claim 1, wherein a desired flow rate for the at least one partial flow (16) through the membrane filtration device (18) is selected from a range of between 0.1% and 50% relative to the volumetric flow of process liquid (4) in the at least one recirculation loop (11) prior to removing the partial flow (16).

3: Method according to claim 1, wherein the partial quantity of process liquid (4) removed from the at least one recirculation loop (11) per unit of time is influenced with a view to obtaining a desired flow rate of the at least one partial flow (16) through the membrane filtration device (18) by adjusting an opening of the at least one flow regulating means (20) with respect to the membrane filtration device (18).

4: Method according to claim 1, wherein a flow regulating position or opening position of the at least one adjustable flow regulating means (20) with respect to the membrane filtration device (18) is continuously monitored.

5: Method according to claim 4, wherein if a threshold value for the flow regulating position or opening position of the at least one flow regulating means (20) is exceeded, action is taken.

6: Method according to claim 1, wherein if there is a drop below a threshold value for the monitored flow rate of the at least one partial flow (16) diverted through the membrane filtration device (18), action is taken.

7: Method according to claim 5, wherein the action taken is back-flushing by reversing a flow direction of a filter module or several or all of the filter modules (24) of the membrane filtration device (18).

8: Method according to claim 1, wherein the flow rate of the diverted partial flow (16) is monitored by means of a sensor device (19) comprising a flow sensor (22).

9: Method according to claim 1, wherein a pressure drop across the membrane filtration device (18) is continuously monitored by means of a sensor device (19) comprising a differential pressure sensor (23) or at least two pressure sensors.

10: Method according to claim 1, wherein a flow rate of the process liquid (4) through individual filter modules (24) or groups of filter modules (24) of the membrane filtration device (18) is continuously monitored respectively by means of a sensor device (19), and the flow rates through the individual filter modules (24) or groups of filter modules (24) are added to obtain a total flow rate across the membrane filtration device (18).

11: Method according to claim 10, wherein if there is a drop below a respectively set threshold value for a flow rate through an individual filter module (24) or a group of filter modules (24), the corresponding individual filter module (24) or the corresponding group of filter modules (24) is back-flushed by reversing a flow direction.

12: Method according to claim 1, wherein a gas flow is applied to the filter module(s) (24) of the membrane filtration device (18) on the retentate side, cyclically or as and when required.

13: Method according to claim 12, wherein a gas flow is applied to the filter module(s) (24) of the membrane filtration device (18) during a back-flushing operation on the retentate side.

14: Method according to claim 1, wherein the flow rate of the at least one partial flow (16) through the membrane filtration device (18) and/or the flow regulating position or opening position of the at least one flow regulating means (20) is logged over a period of time.

15: Method according to claim 14, wherein on detection of a change in the monitored flow rate of the at least one partial flow (16) that is atypical of the method, or on detection of a change in the flow regulating position or opening position of the at least one flow regulating means (20) that is atypical of the method, action is taken.

16: Method according to claim 15, wherein the action taken is adding at least one chemical selected from the group of pH regulators, water softeners, corrosion inhibitors, surfactants and antimicrobial substances to the process liquid (4).

17: Method according to claim 14, wherein the action taken is undertaking maintenance work on the cleaning device (17) or pasteurization plant (1).

18: Method according to claim 1, wherein the food products in the containers (6) are heated in a treatment zone (2) or heated in in several treatment zones (2) successively, then pasteurized in a treatment zone (2) or several treatment zones (2), after which they are cooled in a treatment zone (2) or cooled in several treatment zones (2) successively.

19: Method according to claim 18, wherein the at least one partial flow (16) is removed from a recirculation loop (11) in which the flow of process liquid (4) is at a temperature level of between 20 and 60° C.

20: Method according to claim 1, wherein a partial volumetric flow of process liquid (4) is directed through a heat exchanger (37) of a cooling device (36) depending on requirements.
